(19) United States
(12) Patent Application Publication
(10) Pub. No.: US 2025/0060385 A1
(43) Pub. Date: Feb. 20, 2025

(54) HANDS-FREE SAMPLE INSERTION APPARATUS AND METHODS

(71) Applicant: Siemens Healthcare Diagnostics Inc., Tarrytown, NY (US)

(72) Inventor: Kenneth Galano, Wrentham, MA (US)

(73) Assignee: Siemens Healthcare Diagnostics Inc., Tarrytown, NY (US)

(21) Appl. No.: 18/701,462

(22) PCT Filed: Oct. 17, 2022
(86) PCT No.: PCT/US2022/078188

§ 371 Date: Apr. 15, 2024

Related U.S. Application Data
(60) Provisional application No. 63/257,371, filed on Oct. 19, 2021.

(51) Int. Cl. G01N 35/10

(52) U.S. Cl. CPC G01N 35/1011

(57) ABSTRACT

A sample insertion apparatus enabling a sample to be inserted into a diagnostic analyzer in a hands-free manner. The sample insertion apparatus includes an insertion head having a coupler configured to couple to a sample container having an insertion member, an arm containing a sample probe positioned stationary relative to the arm, and a retraction assembly coupled to the insertion head and configured to cause the sample container to move towards the sample probe to insert the sample probe into the insertion member. Sample insertion and operating methods for hands-free insertion of a sample into a diagnostic analyzer are described, as are other aspects.

This application claims benefit under 35 USC § 119 (e) of U.S. Provisional Application No. 63/257,371, filed Oct. 19, 2021. The entire contents of the above-referenced patent application are hereby expressly incorporated herein by reference.

### FIELD

This disclosure relates to methods and apparatus that provide for insertion of a sample into a diagnostic analyzer.

### BACKGROUND

In medical diagnostics, a sample containing biological material or a component thereof is inserted into the inner confines of a diagnostic instrument or device (hereinafter “diagnostic analyzer”). Such diagnostic analyzers include, but are not limited to, immunoassay instruments adapted to perform molecular tests, hematology analyzers, and chemical analyzers that analyze samples as to their chemical constituents. The sample may be a raw sample of or containing biological material, such as whole blood, blood serum or plasma, plural fluid, urine, interstitial fluid, cerebrospinal fluid, or the like, or a biological sample that may have been previously processed, so as to extract a protein, analyte, or constituent of interest to be identified, characterized, and/or measured.

In some instances, the sample is supplied to the diagnostic apparatus as contained in a syringe having a body and a chamber containing the sample, wherein the sample is transferred into the diagnostic apparatus for analysis.

Existing systems for transferring samples into the diagnostic apparatus include an arm having a telescopic sheath. The syringe is engaged with the telescopic sheath, and the sheath and the syringe are physically moved by a technician to insert a probe (e.g., a needle-like sample probe) into the body of the syringe. Once inserted, transfer of the sample into the diagnostic apparatus can occur. However, in some instances, the body of the syringe may be misaligned or otherwise not properly mounted to the sheath, which can result in improper probe insertion and create a safety issue where the technician's hand could make contact with the sharp needle-like sample probe resulting in injury to the technician. Thus, a sample insertion apparatus and method are needed that enable improved provision of the sample into a diagnostic apparatus.

### SUMMARY

In one embodiment, a sample insertion apparatus is provided. The sample insertion apparatus comprises an insertion head having a coupler configured to couple to a sample container having an insertion member, an arm containing a sample probe positioned stationary relative to the arm, and a retraction assembly coupled to the insertion head and configured to cause the sample container to move towards the sample probe to insert the sample probe into the insertion member.

In another embodiment, a sample insertion apparatus is provided. The sample insertion apparatus comprises a body; a moveable insertion head having a coupler configured to couple to a coupling end of a syringe, the syringe having an insertion member; an arm containing a sample probe positioned stationary relative to the arm; and a retraction assembly coupled to the moveable insertion head and configured to cause the syringe to move towards the sample probe to insert the sample probe into the insertion member, wherein the retraction assembly comprises: a guide assembly, comprising: a guide member coupleable to a body of the sample insertion apparatus, a guide rod assembly including one or more guide rods moveable in the guide member, an insertion head receiver attached to the one or more guide rods, and the moveable insertion head coupled to the insertion head receiver, and a drive bracket secured to the one or more guide rods; and a drive assembly, comprising: a mounting bracket coupleable to a body of the sample insertion apparatus, a drive motor coupled to the mounting bracket, a lead screw, and a transmission assembly coupled to the drive motor and the lead screw.

In yet another embodiment, a sample insertion method is provided. The sample insertion method includes providing an insertion head of a sample insertion apparatus in an extended position, providing an arm proximate to the insertion head, the arm including a sample probe, coupling a sample container to the insertion head, the sample container including an insertion member, and retracting from the extended position, with the aid of a guide assembly and a drive assembly, the insertion head towards the arm and the sample probe to cause insertion of the insertion member of the sample container over the sample probe.

In another method embodiment, a method of operating a diagnostic analyzer method is provided. The method of operating the diagnostic analyzer includes providing a diagnostic analyzer having an apparatus housing, the diagnostic analyzer including a sample insertion apparatus, providing a sample container containing a volume of a sample, coupling the sample container to the sample insertion apparatus, the coupling positioning the sample container substantially external to the apparatus housing, hands-free retracting at least a portion of the sample container within the apparatus housing to insert a sample probe into the sample container, wherein the sample probe is contained entirely within the apparatus housing at all times.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure. This disclosure is intended to cover all modifications, equivalents, and alternatives falling within the scope of the claims.

### BRIEF DESCRIPTION OF THE DRAWINGS

The drawings, described below, are for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1A illustrates a side view of a first example embodiment of a sample insertion apparatus shown in an extended position ready to accept a sample container according to the disclosure.

FIG. 1B illustrates a side view of the first embodiment of the sample insertion apparatus shown in an extended position and having a sample container coupled to an insertion head thereof according to the disclosure.

FIG. 1C illustrates a side view of the first embodiment of the sample insertion apparatus shown in a retracted position causing a sample probe to be inserted into the sample container so that sample can be drawn therefrom as a result of the retraction according to the disclosure.

FIG. 1D illustrates a partial, enlarged, side view of the insertion head and insertion head receiver of the first embodiment of sample insertion apparatus having the sample probe inserted into an insertion member (e.g., a port) of the sample container according to the disclosure.

FIG. 1E illustrates a partial, enlarged, side view of the insertion head and insertion head receiver of another embodiment of sample insertion apparatus having the sample probe inserted into an insertion member (e.g., a penetrable membrane) of the sample container according to the disclosure.

FIG. 1F illustrates an exploded perspective view of the components of the first example embodiment of sample insertion apparatus according to the disclosure.

FIG. 1G illustrates an exploded perspective view of the components of the first example embodiment of sample insertion apparatus as viewed from the side opposite of FIG. 1F according to the disclosure.

FIG. 1H illustrates a perspective view of the components of an arm of the sample insertion apparatus with a sheath shown as surrounding the sample probe, wherein the sheath is shown in an extended position according to the disclosure.

FIG. 1I illustrates a perspective view of the components of the arm of the sample insertion apparatus with the sheath shown in a retracted position exposing the sample probe according to the disclosure.

FIG. 1J illustrates a perspective view of a portion of the arm body and sample probe of the arm with the sheath removed for clarity and illustrating the shape and securement of an example embodiment of the sample probe according to the disclosure.

FIG. 2 illustrates a flowchart of a method of sample insertion according to one or more embodiments of the disclosure.

FIG. 3 illustrates a flowchart of a method of operating a diagnostic analyzer according to one or more embodiments of the disclosure.

### DETAILED DESCRIPTION

This disclosure is directed at apparatus and methods that enable hands-free insertion of a sample probe into a sample container, as well as hands-free provision of a sample into a diagnostic analyzer. According to a first embodiment of the disclosure, a sample insertion apparatus is provided that is configured to receive a sample container containing a sample comprising biological material to be analyzed or measured. The sample insertion apparatus, which can be a functional part of the diagnostic analyzer, allows for hands-free operation and insertion of the sample into one or more internal passages and/or chambers of the diagnostic analyzer, which eliminates the possibility of the technician being exposed to, or injured by, a sample probe. In particular, the technician does not have to hold the sample container (e.g., syringe) when insertion of the sample probe is taking place. Insertion of the sample into the internal portions of the diagnostic analyzer may also occur in a hands-free manner.

In other embodiments, sample insertion and operational methods that are hands-free in operation are provided. Accordingly, the inventors have invented new apparatus and methods that, because of the hands-free operation, are less prone to possible malfunction where a person may be poked by a probe of the apparatus in use.

In one aspect of the disclosure, a sample insertion apparatus is provided. The sample insertion apparatus includes an insertion head having a coupler configured to couple to a sample container that contains an insertion member (e.g., port or penetrable membrane), an arm containing a sample probe positioned stationary relative to the arm, and a retraction assembly coupled to the insertion head and configured to cause the sample container to move towards the sample probe to insert the sample probe into the insertion member so that a sample can be drawn from the chamber of the sample container into the operating parts of the diagnostic analyzer for processing and/or analysis.

In another aspect of the disclosure, a sample insertion method is provided. The sample insertion method comprises providing an insertion head of a sample insertion apparatus in an extended position, providing an arm located proximate to the insertion head, the arm including a sample probe, coupling a sample container to the insertion head, the sample container including an insertion member, and retracting from the extended position, the insertion head towards the arm and the sample probe thereby causing insertion of the insertion member of the sample container over the sample probe. The retracting from the extended position can be accomplished with the aid of a guide assembly and a drive assembly as described herein.

In another method aspect of the disclosure, a method of operating a diagnostic analyzer is provided. The operational method includes providing a diagnostic analyzer having an apparatus housing and a sample insertion apparatus; providing a sample container containing a volume of a sample; coupling the sample container to the sample insertion apparatus, the coupling positioning the sample container substantially external to the apparatus housing; and hands-free retracting at least a portion of the sample container within the apparatus housing to insert a sample probe into the sample container, wherein the sample probe is contained entirely within the apparatus housing at all times.

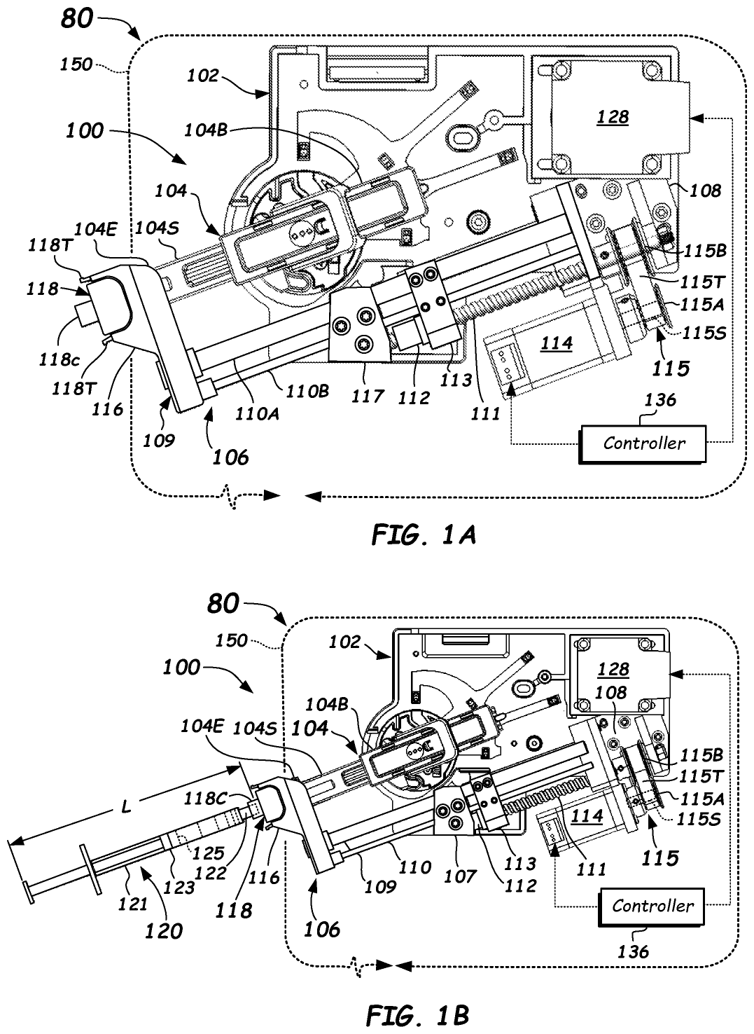

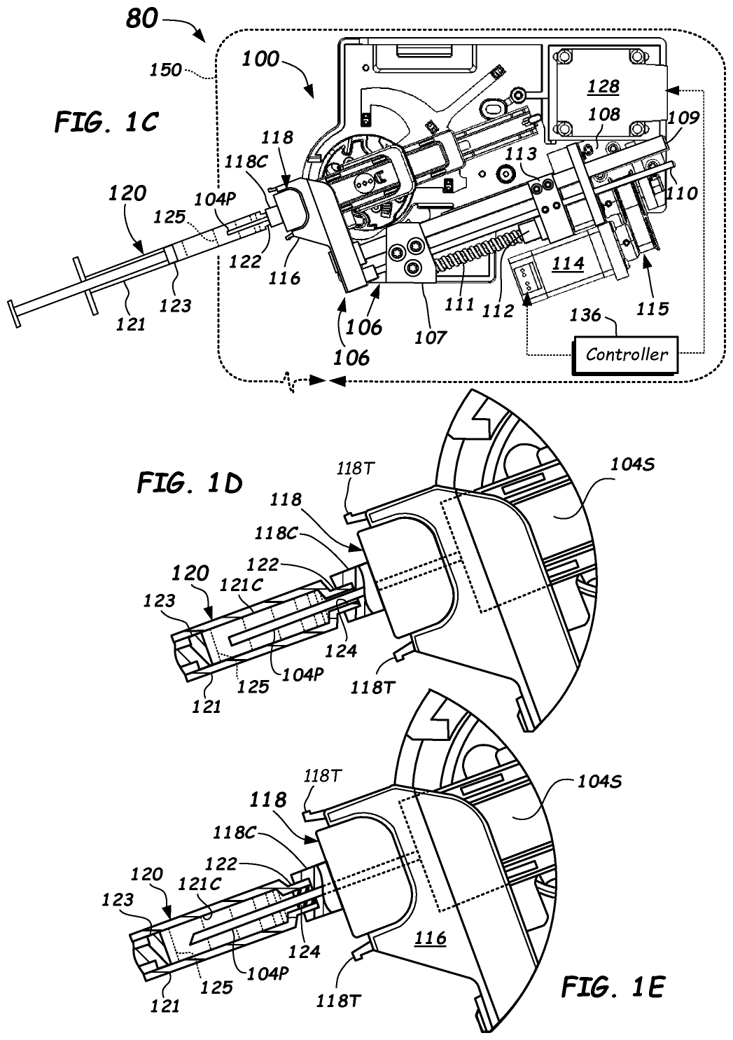

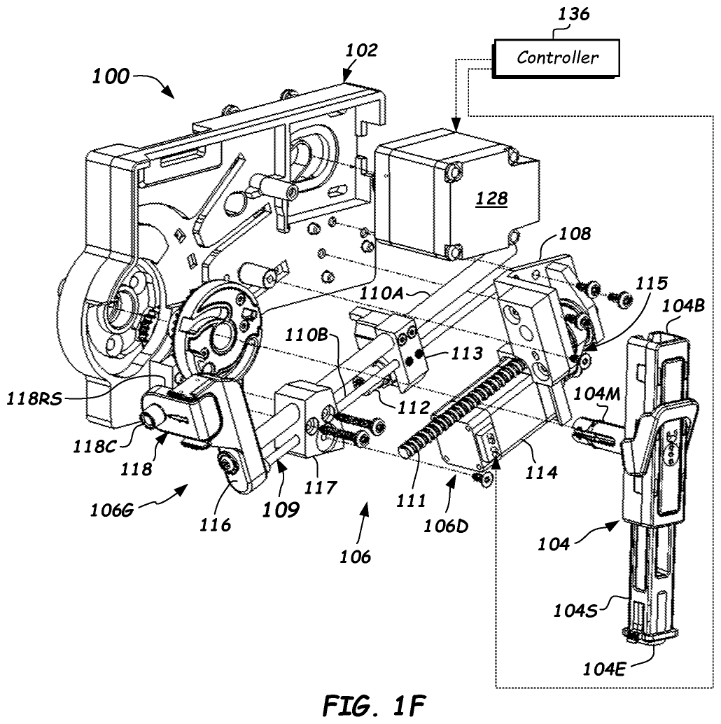

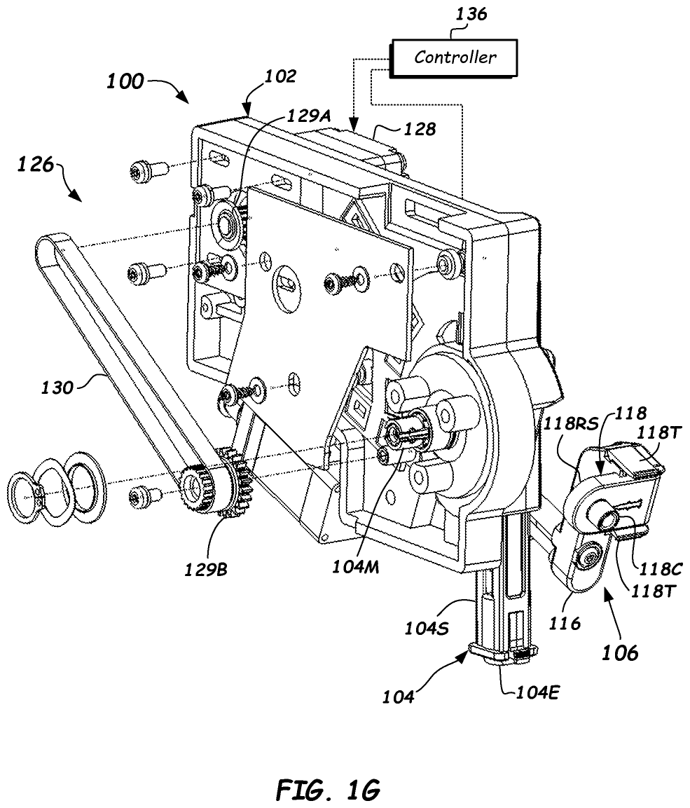

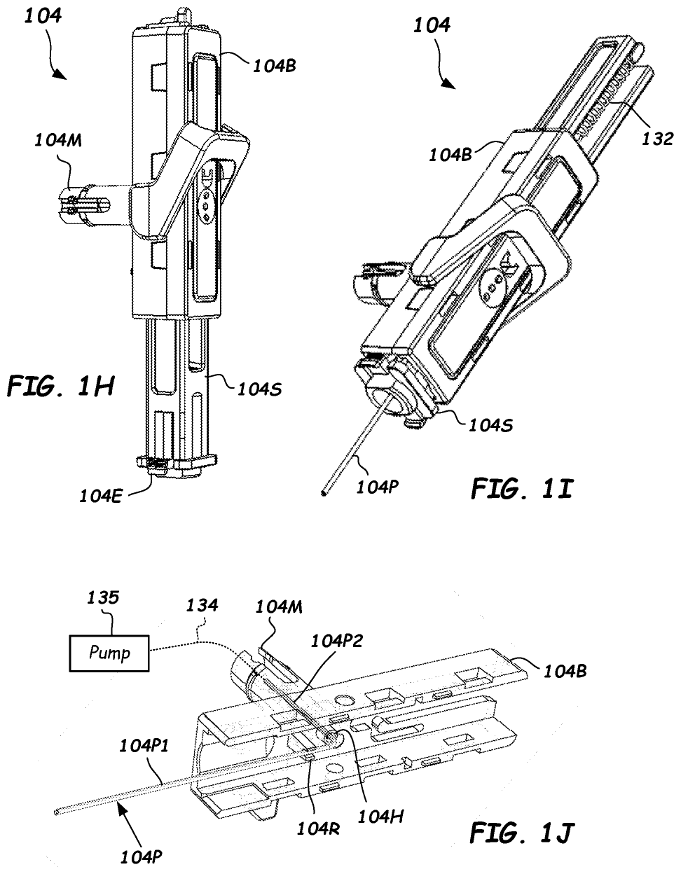

In accordance with the disclosure, several example embodiments of apparatus and methods configured to enable hands-free sample introduction to a diagnostic analyzer are shown and described with reference to FIGS. 1A-3.

FIGS. 1A-1D illustrates a first embodiment of sample insertion apparatus 100, which can be an integrated part of the diagnostic apparatus 80. The details of the rest of the diagnostic analyzer 80 are not described herein and are conventional. The sample insertion apparatus 100 can be used with any type of diagnostic analyzer where a sample is desired to be introduced into the diagnostic analyzer in a hands-free manner. The diagnostic analyzer 80 is shown having an apparatus housing 150 that defines the outer cover surface of the diagnostic analyzer 80 and a sample insertion apparatus 100 according to embodiments is included as part of the diagnostic analyzer 80.

The sample insertion apparatus 100 can include an insertion head 118 that is moveable and has a coupler 118c configured to couple to a portion (e.g., coupling end 122) of a sample container 120 (FIG. 1B) containing a volume of sample 125 therein. The sample container 120 can include an insertion member 124 (FIG. 1D), such as the port (hole) shown. The hole should be slightly larger than a diameter of the sample probe 104P that is receivable therein. In some embodiments, the act of coupling of the sample container 120 to the sample insertion apparatus 100 involves positioning the sample container 120 substantially external to the apparatus housing 150 (FIG. 1B showing the sample container 120 being located entirely external to the apparatus housing 150).

Sample probe 104P may be a needle-like element that is long and slender and includes a hollow passage and may have an outer diameter of about 0.90 mm, for example. The sample probe 104P may be made from stainless steel and may include either a blunt (FIG. 1D) or sharp end (FIG. 1E). Sample probe 104P may be made of other materials, as well. Optionally, in some embodiments, the insertion member 124 may be, or include, a penetrable membrane (e.g., an elastomeric membrane) that can be punctured by the sample probe 104P. In some embodiments, the penetrable membrane can be received or formed in a hole formed at the coupling end 122 of the sample container 120, such as is shown in FIG. 1E. Other forms of the insertion member 124 may be used.

The sample insertion apparatus 100 further includes an arm 104 containing an arm body 104B and the sample probe 104P wherein the sample probe 104P is positioned stationary relative to an arm body 104B of the arm 104 as best shown in FIGS. 1A, 1B, and FIGS. 1G through 1I. The sample probe 104P may be affixed in any suitable manner to the arm body 104B of the arm 104, such as by mounting it in an aperture formed in the arm body 104B, mounting it to a retention feature, and/or by integrally molding the arm body 104B to a portion of the sample probe 104P. In some embodiments, the sample probe 104P is contained entirely within the apparatus housing 150 at all times.

The arm body 104B may include mount 104M (FIG. 1G) that is configured to allow rotation of the arm 104 relative to the body 102 of the sample insertion apparatus 100. For example, arm 104 may be rotatable about a body 102 of the sample insertion apparatus 100 by an arm rotation assembly, such as the arm rotation assembly 126 best shown in FIG. 1F. Arm rotation assembly 126 can include an arm rotation motor 128 coupled to the body 102 and configured to cause rotation of the pulleys 129A, 129B and interconnected belt 130. Pulley 129B attaches to and causes rotation of arm mount 102M and thus causes rotation of arm 104.

As best shown in FIGS. 1H-1J, arm 104 may include a sheath 104S that is hollow and is retractable and extendable relative to the arm body 104B. The retraction may be linear retraction along a channel formed in the arm body 104B. Sheath 104S may be spring loaded against the arm body 104B in some embodiments by using a spring 132 attached between the sheath 104S and the arm body 104. The spring loading can operate to bias the sheath 104S to an extended position as shown in FIG. 1H.

FIGS. 1A and 1B also illustrate the sheath 104S in an extended position so that the sample probe 104P is positioned inside of and surrounded by the sheath 104S. In FIGS. 1A, 1B, and 1H the sample probe 104P is shown surrounded by the sheath 104S and the end of the sheath 104S has been positioned directly proximate to the backside of the insertion head 118 by operation of the arm rotation assembly 126.

As is illustrated in FIG. 1J, the sample probe 104P can be secured to the arm body 104B by any suitable means. For example, as shown, the probe 104P includes a first portion 104P1 extending away from the mount 104M along the length of the arm body 104B, wherein the first portion 104P1 can be secured into retention feature 104R, such as the snap-fit feature shown. Retention feature 104R can be a molded part of the body 104B or could be part of the probe 104P itself. Also shown is a second portion 104P2 that can be approximately perpendicular to the first portion 104P1 and that can pass into a hole 104H and into the mount 104M. Together, hole 104H and retention feature 104R secure the sample probe 104P in place so that it can be aligned with the insertion member 124 as the retraction assembly 106 translates the sample container 120 and insertion head 118 linearly towards the sample probe 104P during retraction. As shown, the sample probe 104P may be connected to a conduit 134 (flexible tube-shown dotted) that is connected to a pump 135 to facilitate through the action of the pump 135, drawing in of the sample 125 into the analyzing internal components of the diagnostic analyzer (not shown).

In more detail, the sample insertion apparatus 100 further includes the retraction assembly 106 coupleable to the insertion head 118 (coupled as shown in FIGS. 1A-1G). Retraction assembly 106 is configured to cause the sample container 120 (e.g., syringe) and insertion head 118 to move (e.g., translate linearly) towards the sample probe 104P (i.e., away from the technician), so as to insert the sample probe 104P into the insertion member 124 (FIG. 1D or 1E) of the sample container 120 in a hands-free manner. In other words, once the technician has coupled the sample container 120 to the insertion head 118, the insertion of the sample probe 104P into the chamber 121C of the sample container 120 is accomplished without the technician holding or otherwise manipulating the sample container 120. Accordingly and in addition to advantageously providing hands-free operation, the retraction assembly 106 prevents the sample probe 104P (1) from being exposed to and (2) from extending or being pushed towards the technician during coupling or engaging of the sample container 120 with the sample probe 104P. This eliminates the possibility of the technician inadvertently making contact with the needle-like sample probe and thus advantageously improving safety of operation. Furthermore, the drawing in of the sample 125 into the diagnostic analyzer (not shown) can also be accomplished in a hands-free manner via the pump 135. For example, the pump 135 hydraulically coupled to the sample probe 104P by conduit 134 may be operated to draw the sample 125 through the probe 104B and through a conduit 134 coupled to the sample probe 104P. FIG. 1J illustrates one embodiment of the sample probe 104P. Other configurations of the sample probe 104P are possible.

In some embodiments, the sample container 120 can be a syringe, such as shown in FIG. 1B, having a container body 121 including a tube-shaped body, a piston 123 moveable in the container body 121, and a coupling end 122 at an end of the container body 121 that engages with the coupling 118C of the insertion head 118. According to some embodiments, the coupling end 122 of the container body 121 contains the insertion member 124. In the depicted embodiment, the insertion member 124 comprises a port in the coupling end 122 that allows the passage of the sample probe 104P into the chamber of the sample container 120 (e.g., into the chamber 121C of the syringe).

In more detail, the retraction assembly 106 can comprise a guide assembly 106G and a drive assembly 106D, as best shown in FIGS. 1F and 1G. For example, in the embodiment shown, the guide assembly 106G can include a guide member 117 and a guide rod assembly 109. Guide member 117 may be rigidly coupleable to the body 102 of the sample insertion apparatus 100, such as by fasteners (e.g., bolts or screws).

Guide rod assembly 109 can be made up of one or more guide rods 110A, 110B, an insertion head receiver 116, and a drive bracket 113. The one or more guide rods 110A, 110B are moveable (slidable) in passages formed in the guide member 117, such as by motion in guide channels formed in the guide member 117 that can have a sliding fit with the one or more guide rods 110A, 110B as shown. The insertion head receiver 116 can be attached to the ends of the one or more guide rods 110A, 110B by any suitable means, such as bolts or screws. Optionally, the insertion head receiver 116 and guide rods 110A, 110B may be integrally formed. The insertion head 118 is configured to be coupled to the insertion head receiver 116, and may be quickly attached and detached therefrom. For example, the insertion head 118 may include tabs 118T, which when depressed towards each other; allow the insertion head 118 to be removed from the insertion head receiver 116. This may be done to replace the insertion head 118 with another fresh insertion head if contaminated.

The drive bracket 113 can be secured to the one or more guide rods 110A, 110B, such as by clamping to the one or more rods 110A, 110B or fastening, such as with set screws, as shown. Other suitable fastening mechanisms may be used. The drive bracket 113 is engaged by the drive assembly 106D in order to retract and extend the insertion head 118. Depending on the type of drive assembly 106D used, the drive bracket 113 may include a driven member. For example, in the case of the drive assembly 106D including a lead screw 111, the drive bracket 113 can comprises a lead nut 112, such as shown, for example.

In the depicted embodiment, the insertion head 118 is located offset from a line of action of the one or more guide rods 110A, 110B. The offset can include both vertical and lateral offsets so as to allow the sheath end 104E of the arm 104 to be alignable in close proximity to the rear surface 118RS of the insertion head 118 as shown in FIGS. 1A, 1B, and 1G, yet allow rotation of the arm 104 without interference with the guide assembly 109.

In more detail yet, the drive assembly 106D is adapted to retract and extend the insertion head 118 and can comprise, as best shown in FIG. 1F, a mounting bracket 108, a drive motor 114, a lead screw 111, and a transmission assembly 115. The mounting bracket 108 can be attached to the body 102 of the sample insertion apparatus 100 in any suitable manner. The attachment to the body 102 may be by way of suitable fasteners, such as bolts or screws, for example. Other suitable fastening mechanisms may be used. Further, the mounting bracket 108 may be integral with the body 102 in some embodiments.

The housing of the drive motor 114 may be coupled directly or indirectly to the mounting bracket 108 and an output shaft 115S (FIG. 1A-1B) thereof may be coupled to the transmission assembly 115. In turn, the transmission assembly 115 is coupled to the lead screw 111. The lead screw 111 engages with a lead nut 112 that may be coupled to the drive bracket 113. Optionally, the drive bracket 113 may have lead screw threads formed integrally into the drive bracket 113. Referring now to FIGS. 1A-1B, in more detail, the transmission assembly 115 can comprise a first pulley 115A coupled to the drive motor 114, such as to the output shaft 115S thereof. Coupling of the first pulley 115A to the output shaft 115S may be by a suitable coupling that may be part of the first pulley 115A. Transmission assembly 115 may also include a second pulley 115B coupled to the lead screw 111, and a belt 115T engaging with the first pulley 115A and the second pulley 115B. Any suitable serpentine belt may be used, such as a V-belt, notched belt, micro rib belt, and the like. Lead screw 111 may have one or more thrust bearing surfaces to allow support of the lead screw in the area of the mounting bracket 108. Lead screw 111 may have any suitable thread pitch, such as from 3 mm to 5 mm, for example. Other thread pitches may be used. Furthermore, other types of linear motion and positioning mechanisms may be used in place of the lead screw 111 and lead nut 112, such as a lead screw and lead nut, linear displacement transducer (LDT), a telescopic reciprocating linear motion actuator, a rack and pinion, a right linear positioner, linear actuator, and the like.

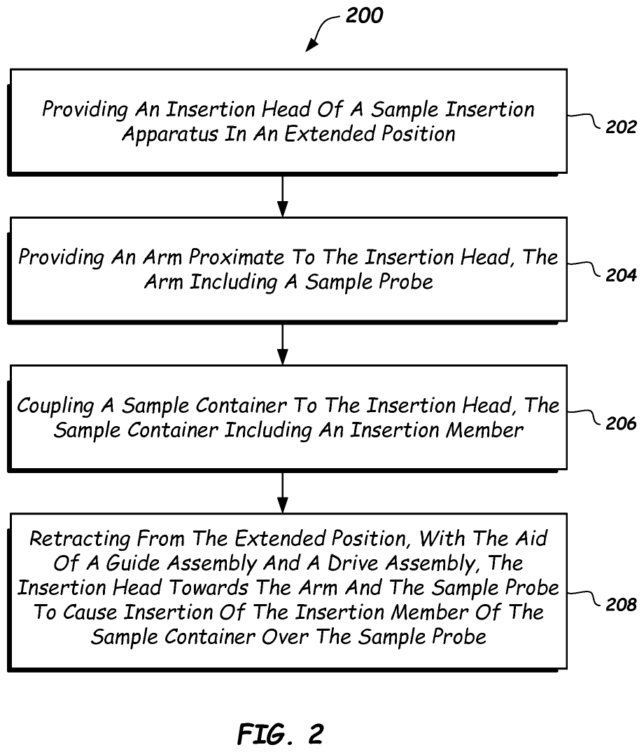

In accordance with another embodiment of the disclosure as best shown in FIG. 2, a sample insertion method 200 is provided. In particular, the method 200 comprises, as best shown in FIG. 2, in block 202, providing an insertion head of a sample insertion apparatus in an extended position. For example, the insertion head 118 of the sample insertion apparatus 100 may be provided in the extended position, as is shown in FIG. 1A. In the extended position, the insertion head 118 can be positioned such that it lies outside of the apparatus housing 150, whose external housing surface is defined by dotted line shown. Apparatus housing 150 and the opening therein may be of any shape to provide an external cover for the diagnostic apparatus and to accommodate the hands-free retraction as well as access to the arm when rotated to other positions.

The method 200 further includes, in block 204, providing an arm proximate to the insertion head, the arm including a sample probe. For example, the arm 104 including the sample probe 104P (as best shown in FIGS. 1I and 1J) can be provided via rotation of the arm rotation motor 128 in a rotational position wherein the sheath end 104E of the sheath 104S is extended and located proximate to, and rotationally aligned with, the insertion head 118 as shown in FIG. 1A. As shown, the sheath 104S and sheath end 104E can be located entirely within and inside of the apparatus housing 150, and the sheath 104S, in the extended position (shown in FIG. 1H), entirely surrounds the sample probe 104P such that the sample probe 104P is not exposed to the technician thereby reducing risk of injury and improving safety.

The method 200 further includes, in block 206, coupling a sample container to the insertion head, the sample container including an insertion member. For example, the sample container 120 can be a syringe as shown in FIG. 1B and the insertion member 124 can comprise a port (FIG. 1D) or a penetrable membrane (FIG. 1E). The coupling of the sample container 120 to the insertion head 118 may be accomplished by a technician coupling a coupling end 122 of the sample container 120 containing the sample 125 to a suitable coupling 118C of the insertion head 118. Coupling may occur through a twist lock feature, such as a Luer lock, or simply a friction fit between the coupling 118C and coupling end 122. Other forms of quick-disconnect couplings may be used.

The method 200 further includes, in block 208, retracting from the extended position, with the aid of a guide assembly and a drive assembly, the insertion head towards the arm and the sample probe to cause insertion of the insertion member of the sample container over the sample probe. For example, the retracting from the extended position (as shown in FIGS. 1A and 1B) to a retracted position as shown in FIGS. 1C and 1D can involve driving the drive bracket 113 of the guide assembly 106G with the drive assembly 106D.

This can be accomplished by driving the drive motor 114 with a drive signal from a controller 136, which causes rotation of the output shaft 115S, thus driving the transmission assembly 115 coupled to the drive motor 114. This, in turn, causes rotation of a lead screw 111 relative to the lead nut 112 attached to the drive bracket 113. Rotating the output shaft 115S rotates the attached first pulley 115A, and in turn interconnected second pulley 115B thus rotating lead screw 111. Rotation of lead screw 111 engages lead nut 112 on drive bracket 113, which retracts guide assembly 109 and the insertion head 118. The guide assembly 106G as described herein may function to guide the insertion head 118 in a linear path when undergoing the retraction from the extended position. The hands-free retracting causes at least a portion of the sample container 120 into and within the apparatus housing 120 as shown in FIG. 1C, wherein a portion of the container body 121 is received inside of the housing 150. Thus, the hands-free retracting causes insertion of the sample probe 104P into the sample container 120 (into the chamber 121C thereof) without exposing the technician to the sample probe 104P thereby improving safety. In other words, rather than a sample probe being pushed toward the technician and out away from an apparatus housing for manual coupling of a sample probe with a sample container by a technician holding a sample container, the hands-free retraction described herein advantageously causes the sample container 120 to be retracted (or pulled) toward the sample probe 104P for coupling therewith within the apparatus housing 120 thereby avoiding exposure of the sample probe to the technician and improving safety.

It should be recognized that sample probe 104P is stationary relative to the arm body 104B, and that during the retracting of the insertion head 118 from the extended position, the sample probe 104P is stationary and fixed in an absolute sense. Accordingly, during the retraction, the retracting insertion head 118 causes the sheath 104S to retract and expose the sample probe 104P (FIG. 1I) for allowing the sample container 120 to go over and engage with the sample probe 104P. After insertion of the insertion member 124 over the sample probe 104P, the drawing in of the sample 125 into the diagnostic analyzer may be accomplished via operation of the pump 135. Following this, the arm 104 and affixed sample probe 104P may be rotated to another position, such as the downward position shown in FIG. 1G so that a flushing operation can take place.

Thus, in summary, as shown in FIGS. 1D and 1E, as a result of the retraction, hands-free insertion of the insertion member 124 of the sample container 120 over the sample probe 104P is accomplished. Thus, sample probe 104P is inserted into the chamber 121C of the sample container 120 containing the sample 125 and the pump 135 (FIG. 1J) of the diagnostic analyzer (not shown) is used to draw the sample 125 out of the sample container 120. In the case of the sample container 120 being a syringe, the piston 123 is retracted as the sample 125 is drawn out of the chamber 121C by the action of the pump 135. After the drawing in of the sample 125 into the diagnostic analyzer 80, the sample container 120 may be removed, and the insertion head 118 may be moved back to the extended position by the guide assembly 106G and drive assembly 106D so that the insertion head 118 is positioned at the ready for coupling of another sample container containing a new sample. Alternatively, after removal of the sample probe 104P from the insertion head 118, the arm 104 may also be rotated to other positions that are not aligned with the insertion head 118 to allow access to the arm 104 and coupling (e.g., direct coupling) of other containers or components to the arm 104, such as a vacutainer tube or capillary tube.

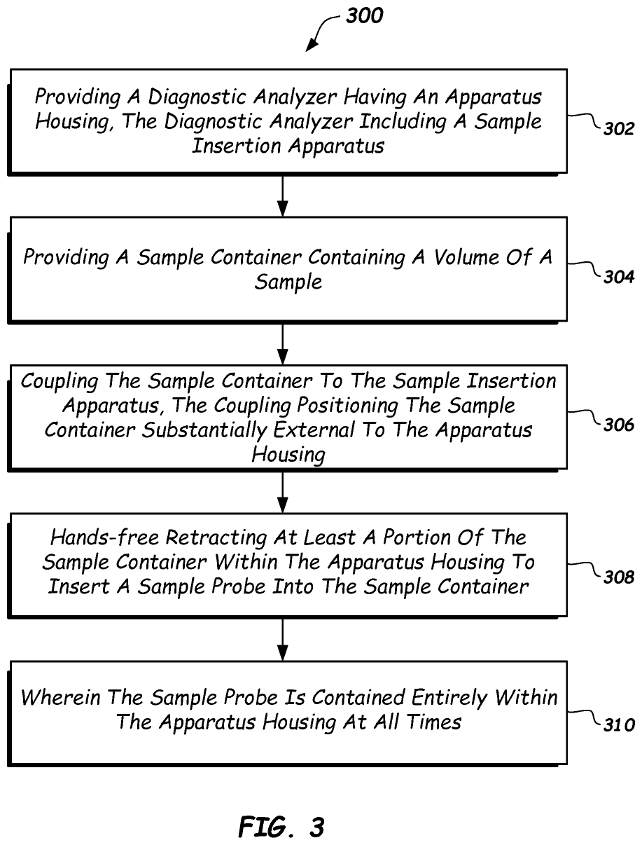

In another method embodiment shown and described with reference to FIG. 3, a method 300 of operating a diagnostic analyzer method is provided. The method 300 includes, in block 302, providing a diagnostic analyzer (e.g., diagnostic analyzer 80) having an apparatus housing (e.g., apparatus housing 150), the diagnostic analyzer including a sample insertion apparatus (e.g., sample insertion apparatus 100). The method 300 further includes, in block 304, providing a sample container (e.g., sample container 120) containing a volume of a sample (e.g., a biological sample such as sample 125), and, in block 306, coupling the sample container to the sample insertion apparatus, the coupling positioning the sample container substantially external to the apparatus housing. As used herein, the terms “substantially external” means that greater than 75% of the length L of the sample container 120 is located external to the housing 150 during the act of coupling. In other words, the insertion head 118 may be slightly recessed inside of the housing 150 in some embodiments. However, it may be desirable to have the insertion head 118 at least partially located external to the housing 150 in some embodiments.

The method 300 further includes, in block 308, hands-free retracting at least a portion of the sample container within the apparatus housing to insert a sample probe (e.g., sample probe 104P) into the sample container, wherein the sample probe is contained entirely within the apparatus housing at all times. Accordingly, the hands-free retracting advantageously causes insertion of the sample probe 104P into the sample container 120 without exposing the sample probe 104P outside the apparatus housing and to the technician, and thus reducing technician injury and improving safety.

As should be recognized, the various sequences of the motions involved in the sample insertion method 200 may take place in any desired order. For example, the coupling of the sample container 120 to the insertion head 118 may occur before rotating the arm 104 to the location proximate to and aligned with the insertion head 118.

In some embodiments of the method 200, the coupling of the sample container 120 to the insertion head 118 comprises first coupling the insertion head 118 to the insertion head receiver 116. For example, prior to coupling the sample container 120, a fresh (uncontaminated) insertion head 118 may be mounted to the insertion head receiver 116 by depressing the tabs 118T and pushing the insertion head 118 into a receiving pocket of the insertion head receiver 116.

While this disclosure is susceptible to various modifications and alternative forms, specific apparatus embodiments and methods thereof have been shown by way of example in the drawings and are described in detail herein. It should be understood, however, that the particular apparatus or methods disclosed herein are not intended to limit the disclosure or the claims.

The following is a list of illustrative embodiments and is intended to complement, rather than displace or supersede, the previous descriptions.

1. A sample insertion apparatus, comprising:
an insertion head having a coupler configured to couple to a sample container having an insertion member;
an arm containing a sample probe positioned stationary relative to the arm; and
a retraction assembly coupled to the insertion head and configured to cause the sample container to move towards the sample probe to insert the sample probe into the insertion member.

2. The sample insertion apparatus of illustrative embodiment 1, wherein the sample container is a syringe.

3. The sample insertion apparatus of any one of illustrative embodiments 1-2, wherein the insertion member comprises a penetrable membrane of the syringe.

4. The sample insertion apparatus of any one of illustrative embodiments 1-3, wherein the retraction assembly comprises:
a guide assembly, and
a drive assembly.

5. The sample insertion apparatus of any one of illustrative embodiments 1-4, wherein the guide assembly comprises:
a guide member coupleable to a body of the sample insertion apparatus;
a guide rod assembly including one or more guide rods moveable in the guide member;
an insertion head receiver attached to the one or more guide rods, wherein the insertion head is coupled to the insertion head receiver; and
a drive bracket secured to the one or more guide rods.

6. The sample insertion apparatus of any one of illustrative embodiments 1-5, wherein the drive bracket comprises a lead nut.

7. The sample insertion apparatus of any one of illustrative embodiments 1-6, wherein the insertion head is located offset from a line of action of the one or more guide rods.

8. The sample insertion apparatus of any one of illustrative embodiments 1-7, wherein the drive assembly comprises:
a mounting bracket coupleable to a body of the sample insertion apparatus;
a drive motor coupled to the mounting bracket;
a lead screw; and
a transmission assembly coupled to the drive motor and the lead screw.

9. The sample insertion apparatus of any one of illustrative embodiments 1-8, wherein the lead screw engages with a lead nut coupled to a drive bracket.

10. The sample insertion apparatus of any one of illustrative embodiments 1-9, wherein the a transmission assembly comprises a first pulley coupled to the drive motor, a second pulley coupled to the lead screw, and a belt engaging the first pulley and the second pulley.

11. A sample insertion apparatus, comprising:
a body;
a moveable insertion head having a coupler configured to couple to a coupling end of a syringe, the syringe having an insertion member;
an arm containing a sample probe positioned stationary relative to the arm; and
a retraction assembly coupled to the moveable insertion head and configured to cause the syringe to move towards the sample probe to insert the sample probe into the insertion member, wherein the retraction assembly comprises:
a guide assembly, comprising:
a guide member coupleable to a body of the sample insertion apparatus,
a guide rod assembly including one or more guide rods moveable in the guide member, an insertion head receiver attached to the one or more guide rods, and the moveable insertion head coupled to the insertion head receiver, and
a drive bracket secured to the one or more guide rods; and
a drive assembly, comprising:
a mounting bracket coupleable to a body of the sample insertion apparatus,
a drive motor coupled to the mounting bracket,
a lead screw, and
a transmission assembly coupled to the drive motor and the lead screw.

12. A sample insertion method, comprising:
providing an insertion head of a sample insertion apparatus in an extended position;
providing an arm proximate to the insertion head, the arm including a sample probe;
coupling a sample container to the insertion head, the sample container including an insertion member; and
retracting from the extended position, with the aid of a guide assembly and a drive assembly, the insertion head towards the arm and the sample probe to cause insertion of the insertion member of the sample container over the sample probe.

13. The sample insertion method of any one of the preceding illustrative embodiments, where the coupling of the sample container to the insertion head comprises first coupling the insertion head to an insertion head receiver.

14. The sample insertion method of any one of the preceding illustrative embodiments, wherein the guide assembly guides the insertion head in a linear path when undergoing the retracting from the extended position.

15. The sample insertion method of any one of the preceding illustrative embodiments, wherein the retracting from the extended position comprises driving a drive bracket of the guide assembly with the drive assembly.

16. The sample insertion method of any one of the preceding illustrative embodiments, wherein the driving the drive bracket comprises driving a transmission assembly coupled to a drive motor, which in turn causes rotation of a lead screw coupled to a lead nut attached to the drive bracket.

17. The sample insertion method of any one of the preceding illustrative embodiments, comprising drawing in the sample following the insertion of the sample probe into the insertion member of the sample container.

18. The sample insertion method of any one of the preceding illustrative embodiments, comprising after the drawing in of the sample, returning the insertion head to the extended position.

19. The sample insertion method of any one of the preceding illustrative embodiments, wherein during the retracting from the extended position the sample probe is stationary.

20. The sample insertion method of any one of the preceding illustrative embodiments, wherein the coupling of a sample container to the insertion head comprises coupling a syringe to the insertion head, and the insertion member comprises a port or a penetrable membrane.

21. A method of operating a diagnostic analyzer, comprising:
providing a diagnostic analyzer having an apparatus housing, the diagnostic analyzer including a sample insertion apparatus;
providing a sample container containing a volume of a sample;
coupling the sample container to the sample insertion apparatus, the coupling positioning the sample container substantially external to the apparatus housing; and
hands-free retracting at least a portion of the sample container within the apparatus housing to insert a sample probe into the sample container,
wherein the sample probe is contained entirely within the apparatus housing at all times.

22. The method of operating a diagnostic analyzer of any one of the preceding illustrative embodiments, wherein an insertion head of the sample insertion apparatus is at least partially located external to the apparatus housing.

What is claimed is:

1. A sample insertion apparatus, comprising:
an insertion head having a coupler configured to couple to a sample container having an insertion member;
an arm containing a sample probe positioned stationary relative to the arm; and
a retraction assembly coupled to the insertion head and configured to cause the sample container to move towards the sample probe to insert the sample probe into the insertion member.

2. The sample insertion apparatus of claim 1, wherein the sample container is a syringe.

3. The sample insertion apparatus of claim 2,
wherein the insertion member comprises a penetrable membrane of the syringe.

4. The sample insertion apparatus of claim 1, wherein the retraction assembly comprises:
a guide assembly, and
a drive assembly.

5. The sample insertion apparatus of claim 4, wherein the guide assembly comprises:
a guide member coupleable to a body of the sample insertion apparatus;
a guide rod assembly including one or more guide rods moveable in the guide member;
an insertion head receiver attached to the one or more guide rods, wherein the insertion head is coupled to the insertion head receiver; and
a drive bracket secured to the one or more guide rods.

6. The sample insertion apparatus of claim 5, wherein the drive bracket comprises a lead nut.

7. The sample insertion apparatus of claim 5, wherein the insertion head is located offset from a line of action of the one or more guide rods.

8. The sample insertion apparatus of claim 4, wherein the drive assembly comprises:
a mounting bracket coupleable to a body of the sample insertion apparatus;
a drive motor coupled to the mounting bracket;
a lead screw; and
a transmission assembly coupled to the drive motor and the lead screw.

9. The sample insertion apparatus of claim 8, wherein the lead screw engages with a lead nut coupled to a drive bracket.

10. The sample insertion apparatus of claim 8, wherein the a transmission assembly comprises a first pulley coupled to the drive motor, a second pulley coupled to the lead screw, and a belt engaging the first pulley and the second pulley.

11. A sample insertion apparatus, comprising:
a body;
a moveable insertion head having a coupler configured to couple to a coupling end of a syringe, the syringe having an insertion member;
an arm containing a sample probe positioned stationary relative to the arm; and
a retraction assembly coupled to the moveable insertion head and configured to cause the syringe to move towards the sample probe to insert the sample probe into the insertion member, wherein the retraction assembly comprises:
a guide assembly, comprising:
a guide member coupleable to a body of the sample insertion apparatus,
a guide rod assembly including one or more guide rods moveable in the guide member, an insertion head receiver attached to the one or more guide rods, and the moveable insertion head coupled to the insertion head receiver, and
a drive bracket secured to the one or more guide rods; and
a drive assembly, comprising:
a mounting bracket coupleable to a body of the sample insertion apparatus,
a drive motor coupled to the mounting bracket,
a lead screw, and
a transmission assembly coupled to the drive motor and the lead screw.

12. A sample insertion method, comprising:
providing an insertion head of a sample insertion apparatus in an extended position;
providing an arm proximate to the insertion head, the arm including a sample probe;
coupling a sample container to the insertion head, the sample container including an insertion member; and
retracting from the extended position, with the aid of a guide assembly and a drive assembly, the insertion head towards the arm and the sample probe to cause insertion of the insertion member of the sample container over the sample probe.

13. The sample insertion method of claim 12, where the coupling of the sample container to the insertion head comprises first coupling the insertion head to an insertion head receiver.

14. The sample insertion method of claim 12, wherein the guide assembly guides the insertion head in a linear path when undergoing the retracting from the extended position.

15. The sample insertion method of claim 12, wherein the retracting from the extended position comprises driving a drive bracket of the guide assembly with the drive assembly.

16. The sample insertion method of claim 15, wherein the driving the drive bracket comprises driving a transmission assembly coupled to a drive motor, which in turn causes rotation of a lead screw coupled to a lead nut attached to the drive bracket.

17. The sample insertion method of claim 12, comprising drawing in the sample following the insertion of the sample probe into the insertion member of the sample container.

18. The sample insertion method of claim 17, comprising after the drawing in of the sample, returning the insertion head to the extended position.

19. The sample insertion method of claim 12, wherein during the retracting from the extended position the sample probe is stationary.

20. The sample insertion method of claim 12, wherein the coupling of a sample container to the insertion head comprises coupling a syringe to the insertion head, and the insertion member comprises a port or a penetrable membrane.

21. A method of operating a diagnostic analyzer, comprising:
providing a diagnostic analyzer having an apparatus housing, the diagnostic analyzer including a sample insertion apparatus;
providing a sample container containing a volume of a sample;
coupling the sample container to the sample insertion apparatus, the coupling positioning the sample container substantially external to the apparatus housing; and
hands-free retracting at least a portion of the sample container within the apparatus housing to insert a sample probe into the sample container,
wherein the sample probe is contained entirely within the apparatus housing at all times.

22. The method of operating a diagnostic analyzer of claim 21, wherein an insertion head of the sample insertion apparatus is at least partially located external to the apparatus housing.
